(19) United States
(12) Patent Application Publication
(10) Pub. No.: US 2007/0176997 A1
(43) Pub. Date: Aug. 2, 2007

(54) Electrostatic actuator, liquid droplet ejection head, liquid droplet ejection device and electrostatic driving device as well as methods of manufacturing them

(75) Inventors: Hiroshi Komatsu, Shimosuwa (JP); Yasushi Matsuno, Matsumoto (JP); Akira Sano, Matsumoto (JP)

Correspondence Address: HARNESS, DICKEY & PIERCE, P.L.C., P.O. BOX 828, BLOOMFIELD HILLS, MI, 48303, US

(73) Assignee: Seiko Epson Corporation

(21) Appl. No.: 11/698,935

(22) Filed: Jan. 26, 2007

(30) Foreign Application Priority Data
Jan. 27, 2006 (JP) 2006-019067

(51) Int. Cl. B41J 2/41

(52) U.S. Cl. 347/112

(57) ABSTRACT

An electrostatic actuator, a liquid droplet ejection head, and a liquid droplet ejection device which have a good response and are driven by a small drive voltage includes a vibration plate as a sheet-shaped movable electrode and an individual electrode acting as a rectangular fixed electrode confronting the vibration plate and having stepped portions or an inclined portion in a long side direction with respect to the vibration plate, wherein the thickness of the vibration plate is reduced according to an order by which the vibration plate is made to abut against the individual electrode by electrostatic attracting force generated between the vibration plate and the individual electrode. Methods of manufacturing the above devices are also disclosed.

The entire disclosure of Japanese Patent Application No. 2006-019067, filed Jan. 27, 2006, is expressly incorporated by reference herein.

### BACKGROUND OF THE INVENTION

1. Field of the Invention

The present invention relates to an electrostatic actuator such as a droplet ejection head and the like for carrying out operation (drive) and the like by subjecting a movable portion to displacement and the like by force applied thereto in a micromachined device, to an electrostatic device such as a liquid droplet ejection device and the like using the actuator, and to methods of manufacturing them.

2. Description of the Related Art

A micromachining technology (MEMS Micro Electro Mechanical Systems) for forming a micro device and the like by processing, for example, silicon and the like has made rapid progress. As examples of a micromachined device formed by the micromachining technology, there are a liquid droplet ejection head (inkjet head) used in a recording (printing) device such as a printer employing, a liquid droplet ejection system, an electrostatic actuator used in a micropump, a wavelength-variable light filter, an electrostatic actuator used in a motor, a pressure sensor, and the like.

A liquid droplet ejection head making use of the electrostatic actuator will be explained as an example of the micromachined device. The recording (print) device employing the liquid droplet ejection system is used to carry out print in any and all of the fields irrespective of household use and industrial use. In the liquid droplet ejection system, a liquid droplet ejection head having, for example, a plurality of nozzles is relatively moved with respect to a target (paper and the like) and carries out print and the like by depositing droplets ejected from the liquid droplet ejection head to predetermined positions of the target. The system is also used to make a color filter in manufacturing a display device using liquid crystal, a display panel (OLED) using an electro luminescence element of an organic compound and the like, a microarray of biological molecule such as DNA, protein, and the like.

As the liquid droplet ejection head, there is a head which has an ejection chamber formed in a part of a flow path to store a liquid and makes use of a method of ejecting droplets from nozzles communicating with the ejection chamber by increasing the pressure in the ejection chamber by flexing (driving) the wall of at least one surface (here, the wall of a bottom surface which will be called a vibration plate hereinafter) of the chamber so that the shape of the wall is deformed. Force to displace and deflect the vibration plate is electrostatic force (in particular, electrostatic attracting force) generated by, for example, using the vibration plate as a movable electrode and applying a voltage (hereinafter, called drive voltage) between the movable electrode and another electrode (fixed electrode) confronting the movable electrode with a space. Since the liquid droplet ejection head carries out a job by being driven making use of the electrostatic force, it acts as an electrostatic actuator.

In the liquid droplet ejection head, to dispose the vibration plate acting as the movable electrode in confrontation with the fixed electrode and to displace the vibration plate, a recessed portion is formed in one substrate, the fixed electrode is disposed on the bottom (bottom wall) of the recessed portion, and the substrate is laminated and joined to another substrate to which the vibration plate is disposed. A space (interval) in which the vibration plate is flexed is called a gap, and the width of the gap is called a gap length.

For example, recently, very fine print and the like are required to the liquid droplet ejection head, and thus nozzles are disposed at increased density. Accordingly, the widths of the vibration plate and the fixed electrode, which correspond to the respective nozzles and constitute the electrostatic actuator are narrowed. When the width of the vibration plate is narrowed, a displaced volume (vibration plate area×distance between confronting electrodes (gap length)) is reduced, and thus the amount of droplets ejected from the nozzles is also reduced. To increase the displaced volume while keeping high density, it is sufficient to increase the gap length. In this case, however, a drive voltage must be increased to obtain necessary electrostatic force.

To cope with this problem, the drive voltage is reduced by forming a groove, in which a slender and rectangular electrode is formed, stepwise in a width (short side) direction so that a gap length between a fixed electrode and a vibration plate is set to at least 2 (refer to, for example, Japanese Unexamined Patent Application Publication No. 2000-318155 (FIGS. 2, 4, 5)).

Further, the durability of a conventional inkjet head is improved in such an arrangement that a groove, in which an individual electrode is formed, is formed stepwise in a width direction so that a gap length is increased in the central portions of the individual electrode and a vibration plate in order to prevent an increase of stress in the central portion of the vibration plate by easing abrupt deflection of the vibration plate in the central portion thereof (refer to for example, Japanese Unexamined Patent Application Publication No. 11-291482 (FIGS. 4 to 7)

The recessed portion (fixed electrodes) described above can be abutted in the portion thereof having a short gap length by a low voltage because it is formed stepwise in the width (short side) direction. However, the effect of it cannot reach the portion of the fixed electrode having a long gap length. As a result, a drive voltage necessary to cause the portion having the long gap length to be abutted cannot help being applied between the electrodes, and thus even if the drive voltage is reduced, the effect of it is very small. In particular, this tendency is more and more increased when the widths of the vibration plate and the fixed are narrowed.

To lower the drive voltage, it is contemplated to make, for example, the vibration plate thin so that it can be easily attracted to the fixed electrode side. However, when the vibration plate is simply made thin, since the natural frequency of the vibration plate is reduced and a time is required until it is stabilized, a response is made bad, thereby the number of times of ejection, an amount of ejection, and a print time are adversely affected.

To overcome the above problems, an object of the present invention is to obtain an electrostatic actuator, a liquid droplet ejection head, a liquid droplet ejection device, and an electrostatic driving device which have a good response and can be driven by a small drive voltage as well as to obtain methods of manufacturing them.

### SUMMARY

An electrostatic actuator according to an aspect of the present invention includes a sheet-shaped movable electrode and a rectangular fixed electrode confronting the movable electrode and formed to have stepped or inclined portions in a long side direction with respect to the movable electrode, wherein the thickness of the movable electrode is reduced according to an order in which the movable electrode is made to abut against the fixed electrode by electrostatic attracting force generated between the movable electrode and the fixed electrode.

According to the aspect of the present invention, since the thickness of the movable electrode is reduced as a gap formed by confrontation is widened according to an order by which abutment is carried out, compliance can be increased and restoring force can be reduced as the gap is widened. As a result, it is possible to carry out abutment by electrostatic force as large as that in the case when the gap is narrow overcoming the reduction of electrostatic force caused by the widened gap. Further, the vibration plate can be driven by a small drive voltage without reducing natural frequency as compared with a case in which the vibration plate is thinned uniformly. In particular, the thickness of the fixed electrode is adjusted by forming the stepped or inclined portions in the long side direction, a large moment can be applied to the movable electrode, thereby the drive voltage can be effectively reduced.

An electrostatic actuator according to an aspect of the present invention includes a sheet-shaped movable electrode and a rectangular fixed electrode having stepped or inclined portions formed thereto in a long side direction such that a gap formed by being opposed to the movable electrode is increased from the edges thereof toward the central portion thereof, the fixed electrode generating electrostatic force in confrontation with the movable electrode, wherein the thickness of the movable electrode is reduced from the edges in the long side direction toward the central portion.

According to the aspect of the present invention, since the thickness of the fixed electrode is reduced in order of carrying out abutment from the edges toward the central portion in the long side direction, compliance can be increased and restoring force can be reduced in the central portion. As a result, abutment can be carried out even in the central portion with electrostatic force as large as that in the portion, where the gap is narrow, overcoming the reduction of electrostatic force caused by the widened gap.

In an electrostatic actuator according to an aspect of the present invention, the movable electrode is formed of stepped portions as many as those of the fixed electrode.

According to the aspect of the present invention, since the fixed electrode and the movable electrode are composed of the same number of stepped portions, the movable electrode can be expected to effectively abut according to the stepped portions of the fixed electrode.

A liquid droplet ejection head according to an aspect of the present invention includes the above mentioned electrostatic actuator, wherein a liquid is pressurized by movable electrodes and ejected from nozzles as droplets.

According to the aspect of the present invention, since the electrostatic actuator is provided, it is possible to secure a desired amount of ejection by increasing a displaced volume without reducing natural frequency, thereby it is possible to obtain a head having a high ejection performance and a small drive voltage. In particular, this arrangement is more effective as the density of nozzles is increased.

A liquid droplet ejection device according to an aspect of the present invention has the liquid droplet ejection head mounted thereon.

According to the aspect of the present invention, since the liquid droplet ejection head is mounted on the liquid droplet ejection device, it is possible to carry out highly fine and high quality print and the like, thereby there can be obtained a liquid droplet ejection device of low power consumption.

An electrostatic driving device according to an aspect of the present invention has the electrostatic actuator mounted thereon.

According to the aspect of the present invention, since the electrostatic actuator is mounted, there can be obtained an electrostatic driving device having an excellent operation performance in a low drive voltage.

A method of manufacturing an electrostatic actuator according to an aspect of the present invention includes a step of forming a boron diffused layer acting as a movable electrode, which is displaced by electrostatic attraction force between the movable electrode and a rectangular fixed electrode formed stepwise or to have an inclined surface in a long side direction, by selectively diffusing boron into a silicon substrate while changing a depth of diffusion depending on a position so that the depth of diffusion is thinned as the width of a gap, which is formed when the movable electrode is caused to confront the fixed electrode, is increased, and a step of forming the movable electrode by wet etching the silicon substrate while remaining only the boron diffused layer.

According to the aspect of the present invention, since thickness of the movable electrode is reduced as the gap, which is formed by causing the movable electrode to confront the fixed electrode stepwise or with inclination in the long side direction, is widened by changing the depth of diffusion of the boron diffused layer depending on a position. As a result, there can be manufactured an electrostatic actuator in which compliance is increased and restoring force is reduced as the gap is widened. Therefore, there can be manufactured an electrostatic actuator which can be driven by a small drive voltage without reducing natural frequency of the movable electrode and in which abutment can be carried out with electrostatic force as large as that at the portion in which the gap is narrow overcoming the reduction of electrostatic force caused by the widened gap.

In a method of manufacturing an electrostatic actuator according to an aspect of the present invention, when boron is diffused, a boron diffused layer having a different depth is formed by sequentially increasing selected portions from a portion at which a boron diffused layer is formed thickest.

According to the aspect of the present invention, since the time necessary to diffuse boron in the boron diffused layer forming step can depend on the diffusion time of boron into the portion where boron is diffused deepest, it is possible to effectively manufacture the electrostatic actuator by reducing the time necessary to diffuse boron.

In a method of manufacturing an electrostatic actuator according to an aspect of the present invention, when boron is diffused, a boron diffused layer is formed at one time at a selected position.

According to the aspect of the present invention, since born is not diffused to the same portion a plurality of times, a condition of roughness and the like can be made uniform on the surface where boron is diffused, thereby an electrostatic actuator having an excellent operation performance can be manufactured.

In a method of manufacturing an electrostatic actuator according to an aspect of the present invention, the electrode substrate is formed by carrying out (1) a step of forming an etching mask on a substrate acting as an electrode substrate, (2) a step of forming a rectangular opening portion having short sides and long sides by etching the etching mask, (3) a step of forming a rectangular recessed portion having short sides and long sides to a portion confronting the opening portion of the etching mask by etching the substrate, (4) a step of forming an opening portion longer than the previous opening portion in a long side direction by expanding the opening portion at both edges in the long side direction by etching the etching mask, (5) a step of forming a stepwise recessed portion to a portion of the substrate confronting the longer opening portion of the mask by etching the substrate, (6) a step of forming a recessed portion having a desired number of stepped portions to the substrate by carrying out the steps (4) and (5) once or a plurality of times, and (7) a step of forming the fixed electrode so that its thickness is made uniform in the recessed portion.

According to the aspect of the present invention, the stepwise recessed portion can be easily formed by repeating a micromachining technology for forming an opening portion to the etching mask and etching the substrate, thereby an electrostatic actuator having an excellent operation performance can be manufactured.

A method of manufacturing a liquid droplet ejection head according to an aspect of the present invention is to manufacture the liquid droplet ejection head by applying the method of manufacturing an electrostatic actuator.

According to the aspect of the present invention, since the method of manufacturing the electrostatic actuator is applied, there can be manufactured a droplet ejection head having a high ejection performance in a small drive voltage. This is effective when a head having nozzles with particularly high density is manufactured.

A method of manufacturing a liquid droplet ejection device according to an aspect of the present invention is to manufacture the liquid droplet ejection device by applying the method of manufacturing a liquid droplet ejection head.

According to the aspect of the present invention, since the method of manufacturing the liquid droplet ejection head is applied, it is possible to manufacture a liquid droplet ejection device of low power consumption which can carry out highly fine and high quality print and the like, thereby there can be obtained a liquid droplet ejection device of low power consumption.

A method of manufacturing an electrostatically driven device according to an aspect of the present invention is to manufacture the electrostatically driven device by applying the method of manufacturing the electrostatic actuator.

According to the aspect of the present invention, since the method of manufacturing the electrostatic actuator is applied, there can be obtained an electrostatic driving device having an excellent operation performance in a low drive voltage.

### BRIEF DESCRIPTION OF THE DRAWINGS

FIG. 1 is a view showing a liquid droplet ejection head according to an embodiment 1 by exploding it;

FIG. 2 is a sectional view of the liquid droplet ejection head;

FIG. 3 is a longitudinal sectional view showing the relation among a recessed portion 11, an individual electrode 12A, and a vibration plate 22;

Parts A to C of FIG. 4 are views (1) explaining the relation between a drive voltage and a gap length;

Parts D to G of FIG. 5 are views (2) explaining the relation between the drive voltage and the gap length;

FIG. 6 is a graph showing an example of the relation between electrostatic attracting force and restoring force with respect to displacement;

Parts A to I of FIG. 7 are views showing an example of steps of manufacturing an electrode substrate 10;

Parts A to I of FIG. 8 are views showing steps of forming a boron diffused layer according to the embodiment 1;

Parts A to F of FIG. 9 are views showing steps of manufacturing a liquid droplet ejection head;

Parts A to G of FIG. 10 are views showing steps of forming a boron diffused layer according to an embodiment 2;

FIG. 11 is an outside appearance view of a liquid droplet ejection device using the liquid droplet ejection head;

FIG. 12 is a view showing an example of main means constituting the liquid droplet ejection device; and

FIG. 13 is a view showing an optical switch using an electrostatic actuator of the present invention.

### DESCRIPTION OF THE PREFERRED EMBODIMENTS

### Embodiment 1

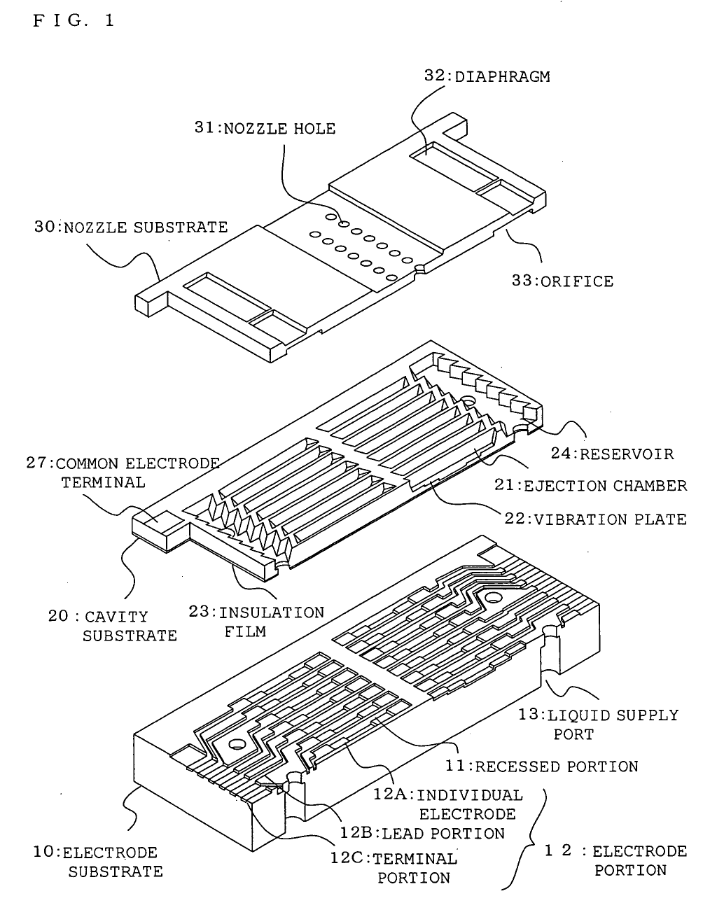

FIG. 1 is view showing a liquid droplet ejection head according to an embodiment 1 of the present invention by exploding it. FIG. 1 partly shows the liquid droplet ejection head. In the embodiment, a face inject type liquid droplet ejection head will be explained as a typical device using an electrostatic actuator driven by an electrostatic system. (Note that, to make illustrated components more understandable, the relation among the sizes of respective components may be different from an actual relation in the following figures including FIG. 1. Further, in the following explanation, it is assumed that upper sides means the upper side of the figures and lower sides means the lower sides of the figures.)

As shown in FIG. 1, the liquid droplet ejection head according to the embodiment is arranged by sequentially laminating three substrates, that is, an electrode substrate 10, a cavity substrate 20, and a nozzle substrate 30 from a lower side. In the embodiment, the electrode substrate 10 is joined to the cavity substrate 20 by anode joint. Further, the cavity substrate 20 is bonded to the nozzle substrate 30 using an adhesive of epoxy resin and the like.

The electrode substrate 10 is mainly composed of an about 1 mm thick substrate of, for example, borosilicate heat resistant hard glass. Although the glass substrate is used in the embodiment, monocrystal silicon, for example, may be used as the substrate. A plurality of recessed portions 11 are formed on the surface of the electrode substrate 10 in conformity with recessed portions acting as ejection chambers 21 of the cavity substrate 20 to be described later. In the embodiment, the portions of the recessed portions 11 corresponding to the ejection chambers 21 (vibration plate 22) are formed stepwise such that the central portions thereof are made deepest particularly in a long side direction and have stepped portions. Although the stepped portions may be formed in a short side direction, they can be more easily processed in the long side direction, thereby an excellent effect can be expected. Further, individual electrode 12A acting as fixed electrodes are disposed to the insides of the recessed portions 11 (in particular, bottom portions) in confrontation with the respective ejection chambers 21 (the vibration plate 22) of the cavity substrate 20, and further lead portions 12B and terminal portions 12C are formed integrally with the individual electrodes 12A (hereinafter, they are called electrode portions 12 together unless it is necessary to discriminate them in particular). The electrode portions 12 are formed by forming ITO (indium tin oxide) on the insides of the recessed portions 11 in a thickness of about 0.1 μm (100 nm) by, for example, sputtering. In the embodiment, the individual electrode 12A has stepped portions similar to those of the recessed portion 11 so that the thickness of the electrode portion 12 is made uniform with respect to the recessed portion 11. A gap, in which the vibration plate 22 can be deflected (displaced), is formed between the vibration plate 22 and the individual electrode 12A by the recessed portions 11. Since the individual electrode 12A is formed stepwise and has stepped portions, a gap length is different depending on a position. Although the individual electrode 12A is formed stepwise by being uniformly formed along the recessed portion 11 formed stepwise, the individual electrode 12A themselves may be formed stepwise. The electrode substrate 10 has a through hole acting a liquid supply port 13 of a flow path through which a liquid supplied from an external tank (not shown) is taken, in addition to the above components.

The cavity substrate 20 is mainly composed of a silicon monocrystal substrate (hereinafter, called silicon substrate) whose surface has, for example, (100) surface orientation, (110) surface orientation, and the like. The cavity substrate 20 has recessed portions (whose bottom walls are arranged as the vibration plate 22 acting as the movable electrodes) formed thereto to temporarily store the liquid. In the embodiment, the vibration plate 22 is also formed stepwise such that central portion thereof is made deepest in particular in a long side direction. Then, an insulation film 23 as a TEOS film (here, Si0₂ film made using tetraethyl orthosilicate tetraethoxysilane) is formed on the lower surface of the cavity substrate 20 (surface confronting the electrode substrate) to a thickness of 0.1 μm (100 nm) by plasma CVD (chemical vapor deposition: also called TEOS-pCVD) to electrically insulate the vibration plate 22 and the individual electrode 12A. Although the insulation film 23 is composed of the TEOS film here, an Al₂O₃ (aluminum oxide (alumina)) film may be used. Further, a recessed portion acting as a reservoir (common liquid chamber) 24 is also formed to the cavity substrate 20 to supply the liquid to the respective ejection chambers 21. Further, the cavity substrate 20 is provided with a common electrode terminal 27 acting as a terminal for supplying a charge having a polarity opposite to that of the individual electrode 12A to the substrate (the vibration plate 22) from an external oscillation circuit.

The nozzle substrate 30 is also mainly composed of, for example, a silicon substrate. The nozzle substrate 30 has a plurality of nozzle holes 31 formed thereto. The respective nozzle holes 31 eject the liquid pressurized by driving (displacing) the vibration plate 22 to the outside as droplets. Since linearity can be expected in ejecting droplets by forming the nozzle hole 31 of a plurality of stepped portions, the nozzle hole 31 is formed of two stepped portions in the embodiment. The nozzle substrate 30 further includes a diaphragm 32 for buffering the pressure applied in the direction of the reservoir 24 at the time the vibration plate 22 is displaced. Further, the nozzle substrate 30 includes an orifice 33 provided on the lower surface for making ejection chambers 21 and the reservoir 24 communicate with each other.

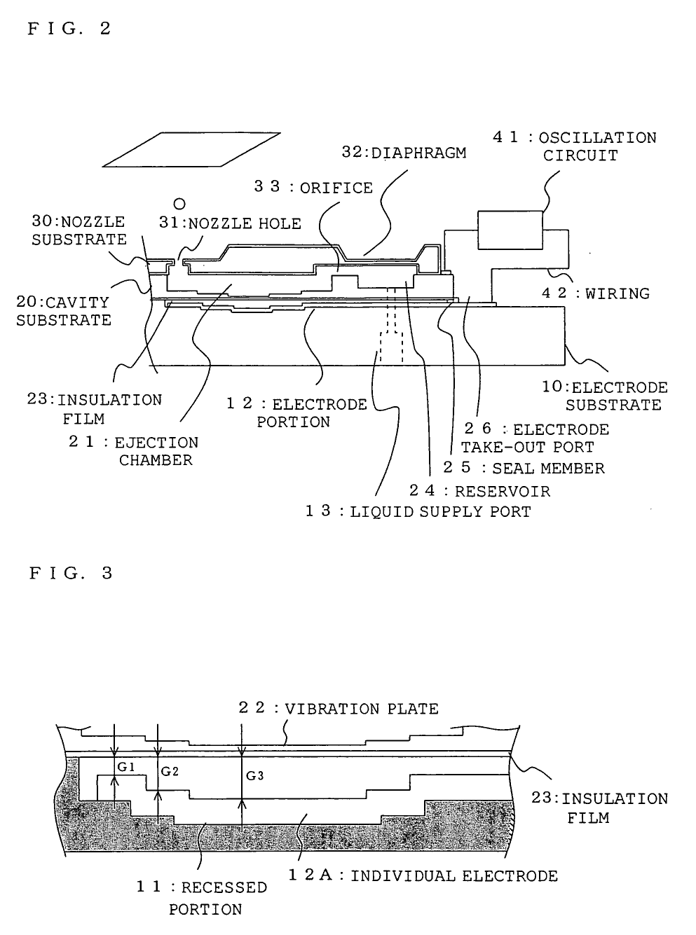

FIG. 2 is a sectional view of the liquid droplet ejection head. A seal member 25 is disposed to an electrode take-out port 26 to shut off the gap from the outside space so that foreign matters, water (water vapor) and the like do not enter the gap. The electrode take-out port 26 is disposed to expose the terminal portions 12C to the outside. An oscillation circuit 41 is electrically connected to the common electrode terminal 27 and the terminal portions 12C exposed from the electrode take-out port 25 through wirings 42 such as wires, an FPC (flexible print circuit) and the like, so as to control supply and stop of a charge (power) to the individual electrodes 12A and the cavity substrate 20 (vibration plates 22). The oscillation circuit 24 is oscillated at, for example, 24 kHz and supplies the charge to the individual electrodes 12A and applies a pulse voltage of, for example, 0 V and 30 V. When the oscillation circuit 24 supplies the charge to the individual electrodes 12A by being oscillated and driven and charges the individual electrodes 12A positively and relatively charges the vibration plate 22 negatively, the vibration plate is attracted to the individual electrodes 12A and deflected by electrostatic force. With this operation, the volume of the ejection chambers 21 is expanded by the displaced volume. Then, when the supply of the charge is stopped, the vibration plate 22 is returned to its original shape (restored). Then, the volume of the ejection chambers 21 at the time is also returned to an original volume, and droplets corresponding to a difference of the volumes are ejected by the pressure. Record such as print and the like is carried out by making the droplets reach, for example, a recording sheet as a target of record.

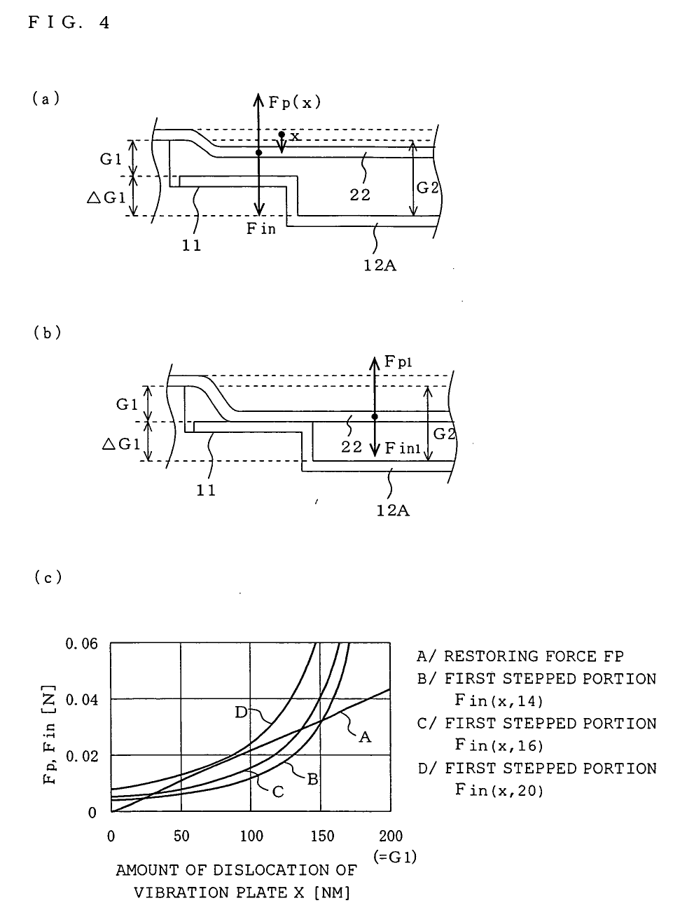

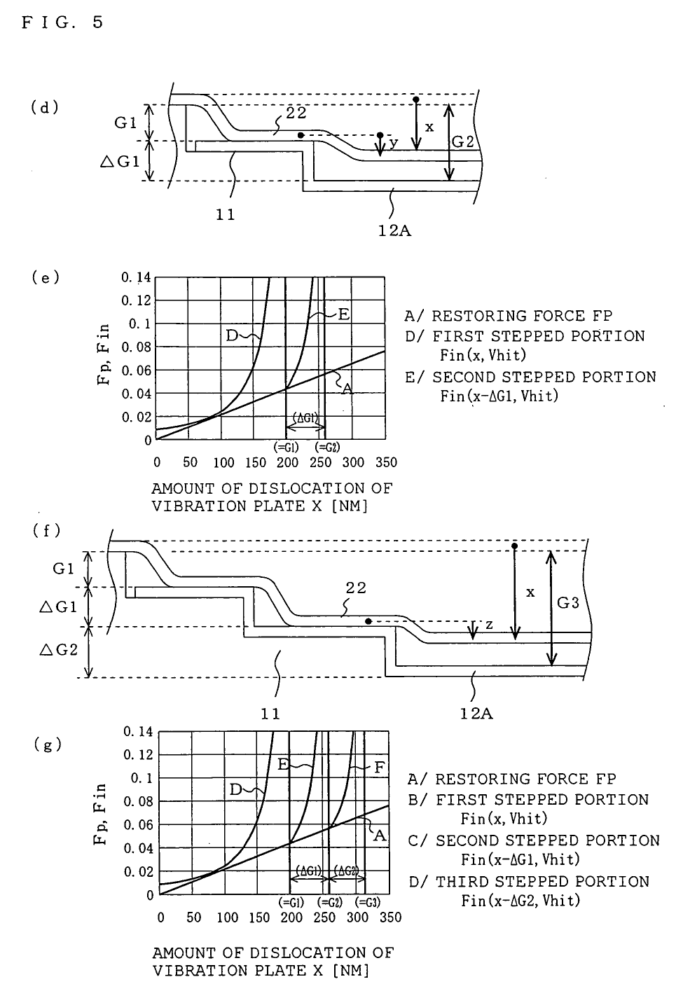

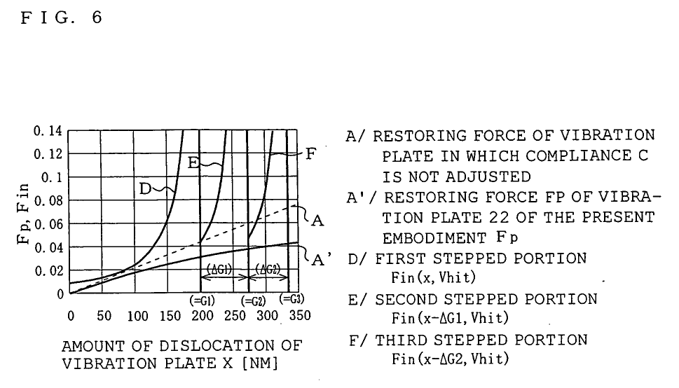

FIG. 3 is a longitudinal sectional view showing the relation among the recessed portion 11, the individual electrode 12A, and the vibration plate 22 of FIG. 1. As shown in FIG. 3, in the liquid droplet ejection head of the embodiment, the recessed portion 11 is formed of three stepped portions, and the individual electrode 12A is formed to the inside of the recessed portion 11 (in particular, to the bottom wall). As described above, the individual electrode 12A is formed with a uniform thickness on the bottom wall of the recessed portion 11, and the gap length between the vibration plate 22 and the individual electrode 12A is set to G3, G2, G1, respectively from a central portions toward outside portions (both the edges). Since the central portion is deepest, the relation of G3>G2>G1 is established. To prevent a break (electric break) of the portions where the stepped portions are formed, the individual electrode 12A is formed thicker than a step difference which the recessed portion 11 has. When reference is made below as to the relation between the vibration plate 22 and the individual electrode 12A such as the gap length and the like, the vibration plate 22 including the insulation film 23 is called the vibration plate 22.

Parts A to C of FIG. 4 and parts D to G of FIG. 5 are views explaining the relation between the drive voltage applied to abut the vibration plate 22 and the gap length. In the embodiment, although the vibration plate 22 is formed of the plurality of stepped portions, explanation will be made as to a vibration plate having no stepped portion to simplify the explanation. Further, although the explanation will be made as to a model in which the vibration plate 22 is sequentially deformed from both the sides of the recessed portion 11 to which strongest electrostatic force is applied, actually, there is a case in which the central portion of the vibration plate 22 is also deflected because electrostatic attracting force is also applied thereto at the same time.

The part A of FIG. 4 is a longitudinal sectional view showing the edge (left side) of the recessed portion 11. The initial position of the vibration plate 22 is shown by dotted lines. When it is assumed that G1 shows the gap length at both the edges of the recessed portion 11, x shows the amount of displacement of the vibration plate 22 in the individual electrode 12A direction, and V shows the difference of potential between the vibration plate 22 and the individual electrode 12A, electrostatic force Fin acting between the vibration plate 22 and the individual electrode 12A at both the edges of the recessed portion 11 is shown by the following expression (1) (α shows a constant). Further, restoring force (force to return to an original state) Fp acting on the vibration plate 22 at the time when it is deflected is shown by the following expression (2).

Compliance C in the expression (2) is determined from the material constant, the size, the thickness, and the like of vibration plate 22 and ordinarily shown by the following expression (3). Here, W shows the width (in the short side direction) of the vibration plate 22, L shows the length (in the long side direction) of the vibration plate 22, E shows Young's modulus, and t shows the thickness of the vibration plate 22. Natural frequency is proportional to the square root of compliance C.

Fᵢₙ=Fᵢₙ(x,V)=α{V/(G1−x)}² (1)

Fₚ=Fₚ(x)=x/C (2)

C=W⁵·L/60Et³ (3)

As shown in the part B of FIG. 4, to abut the vibration plate 22 against both the edges (the gap length G1) of the recessed portion 11, it is sufficient to apply a difference of potential Vhit, by which electrostatic force Fin exceeds restoring force Fp so that the following expression (4) is established, between the vibration plate 22 and the individual electrode 12A as the drive voltage, while the amount of displacement x of the vibration plate 22 is changing.

Fᵢₙ(x,Vₕᵢₜ)>Fp(x) (4)

An example of the relation between electrostatic attracting force Fin and restoring force Fp with respect to the displacement of the vibration plate 22 at both the edges of the recessed portion 11 is as shown in the part C of FIG. 4. The gap G1 is set to 0.2 μm=200 nm. Further, the unit of the difference of potential (drive voltage) is shown by V, and the unit of the amount of displacement of the vibration plate 22 is shown by nm.

As shown in the part C of FIG. 4, when the difference of potential (drive voltage) between the vibration plate 22 and the individual electrode 12A is set to 14 V (line B) and 16 V (line C), there is a portion in which electrostatic attracting force Fin is less than restoring force Fp (line A). This shows that the vibration plate 22 cannot be abutted against the individual electrode 12A. In contrast, when the difference of potential (drive voltage) between the vibration plate 22 and the individual electrode 12A is set to 20 V (line D), since electrostatic attracting force Fin exceeds restoring force Fp at all times, the vibration plate 22 can be abutted against the individual electrode 12A in the portion of the gap length G1, thereby difference of potential Vhit can be set.

Further, when the vibration plate 22 is abutted against the individual electrode 12A in the portion of the gap length G1 as shown the part B of FIG. 4, electrostatic attracting force Fin acting between the vibration plate 22 and the individual electrode and restoring force Fp acting on the vibration plate 22 in the portion of a gap length G2 are shown by the following expressions (5), (6), respectively. Here, it is assumed that ΔG1=G2−G1.

Fᵢₙ₁=Fᵢₙ(ΔG1,Vₕᵢₜ)=α(Vₕᵢₜ/ΔG1)² (5)

Fₚ₁=Fₚ(G1)=G1/C (6)

Under the condition that the difference of stepped portion ΔG1, which satisfies Fp1<Fin1 at all time, is set in case of the drive voltage Vhit, even if the difference of potential between the vibration plate 22 and the individual electrode 12A remains in Vhit, the vibration plate 22 can be deflected and abutted against the individual electrode 12A at the portion of the gap length G2. At the time, electrostatic force Fin acting between the vibration plate 22 and the individual electrode 12A and restoring force Fp acting on the vibration plate 22 in the portion of the gap length G2 are shown by the following expression (7), (8). Here, y shows the amount of displacement (nm) deflected at the portion of the gap length G2, and x=G1+y.

The expressions (7), (8) are arranged making use of this equation.

$$\begin{matrix}{F}_{i n} = {α ( \frac{{V}_{hit}}{Δ G 1 - y} )}^{2} \\ = {α ( \frac{{V}_{hit}}{G 1 - ( G 1 - Δ G 1 + y )} )}^{2} \\ = {α ( \frac{{V}_{hit}}{G 1 - ( x - Δ G 1 )} )}^{2} \\ = {F}_{i n} ( x - Δ G 1 , {V}_{hit} )\end{matrix} \qquad ( 7 )$$

Fp=Fp(G1+y)=Fp(χ) (8)

An example of the relation between electrostatic attracting force Fin and restoring force Fp with respect to the displacement of the vibration plate 22, to which the portion of the gap length G2 is added, is as shown in the part E of FIG. 5. When ΔG1 is appropriately set as shown in the part E of FIG. 5, electrostatic force Fin exceeds restoring force Fp at all times even in the portion of the gap length G2, thereby the vibration plate 22 can be abutted against the portion of the gap length G2 of the individual electrode 12A while keeping the difference of potential between the vibration plate 22 and the individual electrode 12A to Vhit.

Likewise, the portion in which the gap length of the central portion is set to G3 will be examined. In a state in which the vibration plate 22 is abutted against the portion of the gap length G2 of the individual electrode 12A as shown in a part F of FIG. 5, electrostatic attracting force Fin2 acting between the vibration plate 22 and the individual electrode 12A and restoring force Fp2 acting on the vibration plate 22 in the portion of the gap length G3 are shown by the following expressions (9), (10), respectively. Here it is assumed that ΔG2=G3−G2.

Fᵢₙ₂=Fᵢₙ(ΔG2,Vₕᵢₜ)=α(Vₕᵢₜ/ΔG2)² (9)

Fₚ₂=Fₚ(G2)=G2/C (10)

Under the condition that the difference of stepped portion ΔG2, which satisfies Fp2<Fin2 at all time, is set in the case of the drive voltage Vhit, even if the difference of potential between the vibration plate 22 and the individual electrode 12A remains in Vhit, the vibration plate 22 can be deflected and abutted against the individual electrode 12A at the portion of the gap length G3. At the time, electrostatic force Fin acting between the vibration plate 22 and the individual electrode 12A and restoring force Fp acting on the vibration plate 22 at the portion of the gap length G3 are shown by the following expressions (11), (12). Here, z shows the amount of displacement (nm) deflected at the portion of the gap length G3, and x=G2+z=G1+ΔG1+z.

The expressions (11), (12) are arranged making use of this equation.

$$\begin{matrix}{F}_{i n} = {α ( \frac{{V}_{hit}}{Δ G 2 - z} )}^{2} \\ = {α ( \frac{{V}_{hit}}{G 1 - ( G 1 - Δ G 2 + z )} )}^{2} \\ = {α ( \frac{{V}_{hit}}{G 1 - ( x - Δ G 1 - Δ G 2 )} )}^{2} \\ = {F}_{i n} ( x - Δ G 1 - Δ G 2 , {V}_{hit} )\end{matrix} \qquad ( 10 )$$

Fₚ=Fₚ(G2+z)=Fₚ(χ) (11)

An example of the relation between electrostatic attracting force Fin and restoring force Fp with respect to the displacement of the vibration plate 22 to which the portion of the gap length G3 is added is as shown in a part G of FIG. 5. As shown in the part G of FIG. 5, when ΔG2 is appropriately set, electrostatic force Fin exceeds restoring force Fp at all times even at the portion of the gap length G3, thereby the vibration plate 22 can be abutted against the portion of the gap length G3 of the individual electrode 12A while remaining the difference of potential between the vibration plate 22 and the individual electrode 12A in Vhit.

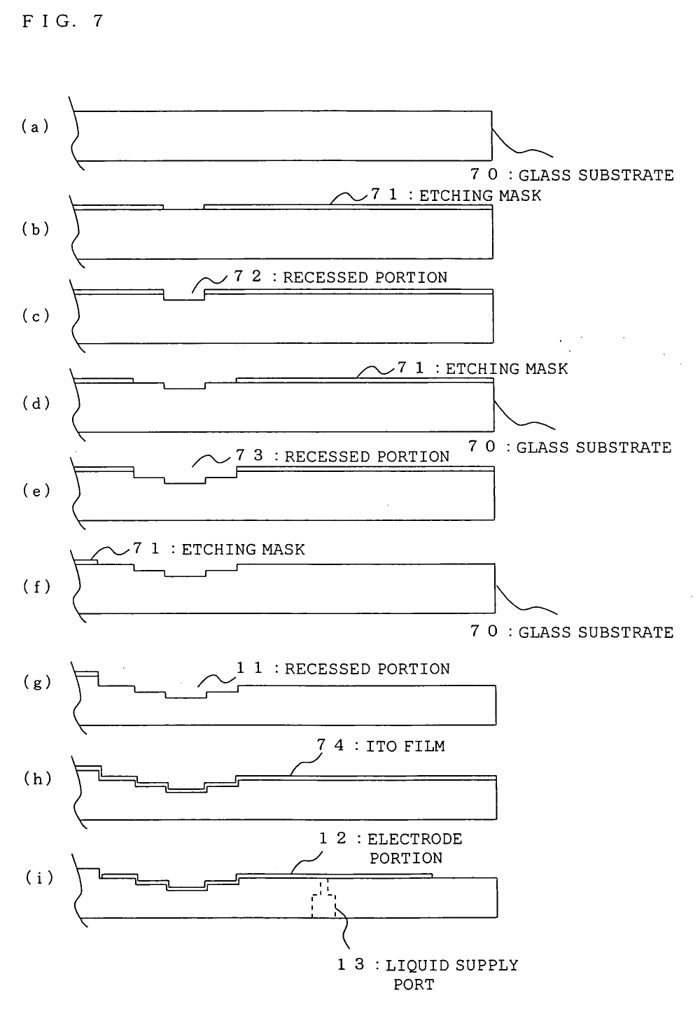

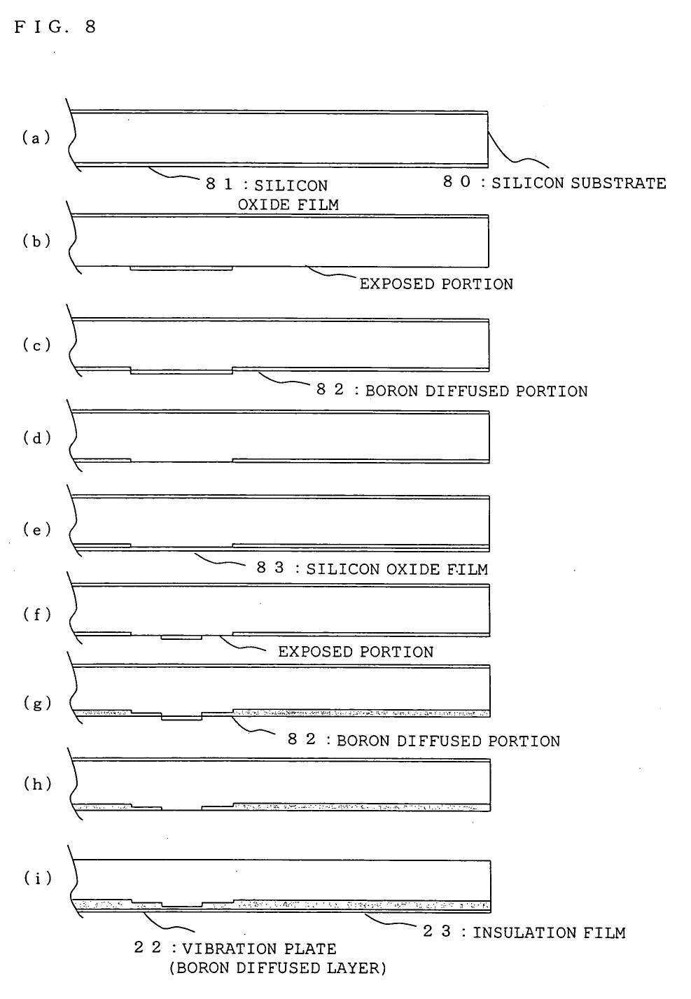

FIG. 6 is a graph showing an example of the relation between electrostatic attracting force Fin and restoring force Fp with respect to the displacement of the vibration plate 22 of the embodiment. Fundamentally, since restoring force Fp forms a straight line which linearly increases in proportion to the amount of displacement x, the relation of Fp(0)<Fp1<Fp2 is established. Accordingly, since Fin(0, Vhit)<Fin1<Fin2, the limit of G1>ΔG1>ΔG2 is applied as to the gap length. The above relation is the same if the individual electrode 12A is formed of four step portions or more.

Thus, in the embodiment, as to both the edges of the vibration plate 22, which act as boundaries to the portions of the cavity substrate 20 that are joined to and supported by the electrode substrate and also act as portions from which the vibration plate 22 begins to deflect, the vibration plate 22 is also formed of a plurality of stepped portions by being formed in a thin thickness which does not damage a response without reducing natural frequency while satisfying the expression (4), so that the compliance C is increased toward the central portion (in a direction farther from the support portions). Accordingly, as shown in a line A′ of FIG. 6, it is certain that the curve for restoring force Fp is made up of a curved line (may be approximately made up of a straight line) whose inclination is smaller than a straight line for the compliance C of the vibration plate 22 uniformly formed at least with the same thickness (in FIG. 6, although the line A′ for the restoring force of the vibration plate 22 is formed based on prediction, it can be assumed that the restoring force has a line near to it). As a result, an ejection performance can be increased by increasing the displaced volume by increasing the displacement while maintaining the response without being limited by G1>ΔG1>ΔG2. In the embodiment, although the vibration plate 22 and the individual electrode 12A (recessed portion 11) are formed of the three stepped portions expecting that the vibration plate 22 is abutted along the line of the individual electrode 12A, the embodiment is not limited thereto. Compliance C can be optionally adjusted by the vibration plate 22, and the number of stepped portions can be adjusted according to adjusted compliance C.

Portions A to I of FIG. 7 are views showing an example of manufacturing steps of the electrode substrate 10. How the electrode substrate 10 according to the embodiment is manufactured will be explained based on FIG. 7. When the liquid droplet ejection head is manufactured, actually, a plurality of each substrate such as the electrode substrate 10 are manufactured at the same time in a unit of wafer and separated individually after each substrate is joined to other substrate, and the like. However, the following views showing the respective steps show sectional views where a part of one liquid droplet ejection head is cut in a long side direction.

First, a glass substrate 70 having a thickness of, for example, 2 to 3 mm is ground until the thickness of a substrate 3a is made, for example, about 1 mm by mechanical grinding, etching, and the like. Then, the glass substrate 70 is etched, for example, 10 to 20 μm, thereby a processing deterioration layer is removed (part A of FIG. 7). The processing deterioration layer may be removed by dry etching, for example, SF₆ and the like, spin etching by using hydrofluoric acid aqueous solution, and the like. When the dry etching is carried out, the processing deterioration layer formed on one surface of the substrate 70 can be effectively removed without the need of protecting an opposite surface. Further, when the spin etching (wet etching) is carried out, only a small amount of etching solution is necessary. Further since fresh etching solution is supplied at all times, etching can be carried out stably.

A film, which acts as an etching mask 71 and is composed of chromium (Cr), is entirely formed one surface of the glass substrate 70 by, for example, sputtering. Then, a resist (not shown) is patterned on a surface of the etching mask 71 by photolithography in correspondence to the shape (rectangular shape) of the central portion (portion of the gap length G3), and, wet etching is carried out so that the glass substrate 70 is exposed (part B FIG. 7). Thereafter the glass substrate 70 is wet etched with, for example, hydrofluoric acid aqueous solution, thereby a recessed portion 72 is formed (part C of FIG. 7). The amount of etching (etching depth) at the time is made as large as a step difference between the portion of the gap length G3 and the portion of the gap length G2.

Then, patterning is carried out in correspondence to the shape of the portion of the gap length G2 by photolithography, and wet etching and the like are carried out, thereby the portion of the gap G2 (part D of FIG. 7) of the glass substrate 70 is also exposed. Then, the glass substrate 70 is wet etched with, for example, hydrofluoric acid aqueous solution, thereby a recessed portion 73 is formed (part E of FIG. 7). The amount of etching (etching depth) at the time is made as large as the step difference between the portion of the gap length G2 and the portion of the gap length G1. With this arrangement, the recessed portion 73 is formed of two stepped portions.

Further, wet etching and the like are carried out after patterning is carried out in correspondence to the shape of the portion of the gap length G1 (including the portion where a lead portion 12B and a terminal portion 12C are formed) by photolithography, thereby the glass substrate 70 of the portion of the gap length G1 is also exposed (part F of FIG. 7). Then, the glass substrate 70 is wet etched with, for example, hydrofluoric acid aqueous solution, thereby a recessed portion 11 is finally formed (part G of FIG. 7). Further, an atmosphere opening hole (not shown) is formed at subsequent step so that the pressure in the gap is made as high as external pressure. The amount of etching (etching depth) at the time is made as large as the gap length G1. If a recessed portion 11 having, at least four stepped portions is to be formed, the above steps are repeated.

Thereafter, an ITO film 74 is formed by, for example, sputtering on the overall surface of the glass substrate 70 on which the recessed portion 11 is formed (part H of FIG. 7). At the time, the ITO film 74 is formed thicker than any difference of the stepped portions formed stepwise to the recessed portion 11 to prevent a break. Then, a resist (not shown) is patterned by photolithography, and the ITO film 74 is etched after a portion to be left as an electrode portion 12 is protected. Further, a through hole acting as a liquid supply port 13 is formed by sand blast or cutting (part I of FIG. 7). The electrode substrate 10 is formed by the above steps.

Parts A to I of FIG. 8 are views of steps for forming a boron diffused layer acting as the vibration plate 22 of the embodiment 1. First, one surface (surface joined to the electrode substrate 10) of the silicon substrate 80 is subjected to mirror polishing and the like, thereby a substrate (turned to the cavity substrate 20) having a thickness of, for example, 220 μm is formed. Then, a silicon oxide (Si0₂) film 81, which acts as a mask when boron is diffused, is formed on a surface of the silicon substrate 80 to provide the vibration plate 22 with a thickness sufficient to form a plurality of stepped portions (here, three stepped portions) in the vibration plate 22 (part A of FIG. 8).

Next, a resist is coated on the silicon oxide film 81 and patterned by being exposed to light by photolithography so that the silicon substrate 80 is exposed. Then, the silicon oxide film 81 in the opening of the resist is etched with hydrofluoric acid aqueous solution and the like by, for example, wet etching, and the portion of the silicon substrate 80, to which boron is diffused, is exposed (part B of FIG. 8). The portion, where the silicon substrate 80 is exposed, is the portion where the boron diffused layer is made thickest.

Then, the silicon substrate 80 is put into a vertical furnace with the surface thereof, on which the boron diffused layer is formed, facing a solid boron diffusion source mainly composed of B₂O₃, and boron is diffused into the portion where the silicon substrate 80 is exposed. This portion is arranged as a boron diffused portion 82 (part C of FIG. 8). On the completion of boron diffusion, the silicon oxide film 81 is removed (part D of FIG. 8).

Further, a silicon oxide (Si0₂) film 83 is formed on the surface of the silicon substrate 80 (part E of FIG. 8). Then, the silicon oxide film 83 is patterned by photolithography by a method similar to the method described above, and a predetermined portion of the silicon substrate 80 is exposed (part F of FIG. 8). Here, the portion, where the silicon substrate 80 is exposed, is turned to a portion, where the boron diffused layer is made thickest, and a portion, where the boron diffused layer is made second-thickest. Thereafter, boron is further diffused into the portion, where the silicon substrate 80 is exposed, by a method similar to the method described above (part G of FIG. 8). Boron is diffused into a deeper portion of the initially boron diffused portion 82 by the above diffusion. On the completion of boron diffusion, the silicon oxide film 83 is removed and the overall surface of the silicon substrate 80 is exposed (part H of FIG. 8).

Then, boron is further diffused into the overall surface where the silicon substrate 80 is exposed. With these steps, a boron diffused layer composed of three stepped portions is completed. This boron diffused layer is used as the vibration plate 22. An insulation film 25 is formed in a thickness of 1 μm on the surface of the silicon substrate 80, on which the boron diffused layer is formed, by plasma CVD under the condition of a processing temperature of 360° during forming the film, a radio frequency output of 250 W, a pressure of 66.7 Pa (0.5 Torr), a gas flow rate of 100 cm³/min (100 sccm) in terms of a TEOS flow rate, and an oxygen flow rate of 1000 cm³/min (1000 sccm) (part I of FIG. 8).

Parts A to F of FIG. 9 are views showing manufacturing steps of the liquid droplet ejection head. After the silicon substrate 80 and the electrode substrate 10 described above are heated to 360°, a negative electrode is connected to the electrode substrate 10 and a positive electrode is connected to the silicon substrate 80, and they are anode-joined to each other by applying a voltage of 800 V. At the time, a glass may be electrochemically decomposed so that oxygen is generated as a gas in the interface between the silicon substrate 80 and the electrode substrate 10. Further, a gas adsorbed in the surface of the silicon substrate 80 may be generated by heating. However, since these gases escape from the atmosphere opening hole, the interior of the gap does not become positive pressure. Then, in the anode-joined substrate (hereinafter, called joined substrate), the surface of the silicon substrate 80 is ground until the thickness thereof is made about 60 μm. Thereafter, to remove a processing deterioration layer, the silicon substrate 80 is subjected to wet etching of about 10 μm with potassium hydroxide solution having a concentration of 32 w %. With this step, the thickness of the silicon substrate is made to about 50 μm (part A of FIG. 9).

At the grinding step and the processing deterioration layer removing step, the atmosphere opening hole is closed and protected using a one surface protection jig, a tape, and the like so that no liquid enters the gap from the atmosphere opening hole. Since the substrate is heated again at next step, there is a possibility that a gas is generated in the gap. To cope with this problem, the atmosphere opening hole is not completely closed at this step so that the gap (recessed portion 11) can communicate with the outside.

Next, an etching mask 90 composed of TEOS (hereinafter, called TEOS etching mask) is formed by plasma CVD on the surface of the silicon substrate 80 subjected to the wet etching. The film is formed with a thickness of about 1.0 μm under the condition of, for example, a processing temperature of 360° during forming the film, a radio frequency output of 700 W, a pressure of 33.3 Pa (0.25 Torr), a gas flow rate of 100 cm³/min (100 sccm) in terms of a TEOS flow rate, and an oxygen flow rate of 1000 cm³/min (1000 sccm) (part B of FIG. 9). When TEOS is used, the film can be formed at a relatively low temperature, which is convenient to suppress heating of the substrate as much as possible. After the TEOS etching mask 90 is formed, the atmosphere opening hole is hermetically sealed by pouring, for example, an epoxy adhesive and the like thereinto. With this step, since the gap is in a hermetically sealed state, no liquid and the like enter from the atmosphere opening hole in subsequent steps. Since the atmosphere opening hole is hermetically sealed after the TEOS etching mask 90 is formed, the gas in the gap can be prevented from being expanded by the heating during forming the mask 90.

Then, a resist is patterned to etch the TEOS etching mask 90 in the portions acting as the ejection chamber 21 and the electrode take-out port 26. Then, the TEOS etching mask 90 is patterned by etching the portions using hydrofluoric acid aqueous solution until the TEOS etching mask 90 is removed, thereby the silicon substrate 80 is exposed. After the etching is carried out, the resist is removed. As to the portion arranged as the electrode take-out port 26, the portion acting as the boundary between, for example, the electrode take-out port 26 and the cavity substrate 20 may be exposed and the remaining portion of it may be left in an island state, without exposing the overall silicon to prevent cracking of the silicon.

Further, a resist is patterned to etch the TEOS etching mask 90 in the portion acting as the reservoir 24. Then, patterning is carried out by etching the TEOS etching mask 90 in the portion by about 0.7 μm with hydrofluoric acid aqueous solution. With this step, although the thickness of the TEOS etching mask 90 remaining in the portion acting as the reservoir 24 is made about 0.3 μm, no silicon substrate is exposed. Although the thickness of the TEOS etching mask 43 to be left is set to about 0.3 μm here, it is necessary to adjust the thickness depending on a desired depth of the reservoir 24. After the etching is carried out, the resist is removed (part C of FIG. 9).

Next, the joined substrate is dipped into potassium hydroxide aqueous solution having a concentration of 35 wt %, and wet etching is carried out until the thicknesses of the portions, where the silicon is exposed, acting as the ejection chamber 21 and the electrode take-out port 26 are made about 10 μm. Thereafter, the TEOS etching mask 90 of the portion acting as the reservoir 24 is removed by carrying out etching by dipping the joined substrate into hydrofluoric acid aqueous solution. Then, the joined substrate is further dipped into potassium hydroxide aqueous solution having a concentration of 3 wt %, and etching is continued until it is determined that etching stop is sufficiently effected in the boron diffused layer. As described above, it is possible to suppress the surface of the vibration plate 22 to be formed from being roughed and to set thickness accuracy to 0.80±0.05 μm or less by carrying out the etching using the two types of potassium hydroxide aqueous solutions having different concentrations. As a result, an ejection performance of the liquid droplet ejection head can be stabilized. Then, the vibration plate 22 formed stepwise (three stepped portions) appears in this step (part D of FIG. 9).

After the completion of the wet etching, the joined substrate is dipped into hydrofluoric acid aqueous solution, and the TEOS etching mask 90 on the surface of the silicon substrate 80 is removed. Then, to remove the silicon of the portion acting as the electrode take-out port 26 of the silicon substrate 80, a silicon mask having an opening for a portion acting as the electrode take-out port 26 is attached to the surface of the joined substrate on the silicon substrate 80 side. Then, plasma is applied only to a portion acting as the electrode take-out port 26 and the portion is opened by carrying out RIE dry etching (anisotropic dry etching) for 24 hours under the condition of, for example, RF power of 200 W, a pressure of 40 Pa (0.3 Torr), a CF₄ flow rate of 30 cm³/min (30 sccm). The gap is also opened to the atmosphere by opening the portion. Here, the silicon of the portion acting as the electrode take-out port 26 may be removed by jabbing it with a pin and the like.

Then, the gap is hermetically sealed by pouring a seal member 25 composed of, for example, epoxy resin along the edge of the electrode take-out port 26 (opening portion of the gap formed between the cavity substrate 20 and the recessed portion of the electrode substrate 10). Further, a mask having an opening for a portion acting as the common electrode terminal 27 is attached to the surface of the joined substrate on the silicon substrate 80 side. Then, sputtering and the like are carried out using, for example, platinum (Pt) as a target, thereby the common electrode terminal 27 is formed. Further, a through hole is formed to the silicon substrate 80 to make the liquid supply port 13 communicate with the reservoir 24. To protect the cavity substrate 20 from the liquid flowing in the flow path, a liquid protection film (not shown) of for example, silicon oxide and the like may be further formed. With this step, processing carried out to the joined substrate is finished (part E of FIG. 9).

The nozzle substrate 30, which is manufactured by previously forming the nozzle holes 31, the diaphragms 32, and the orifices 33, is bonded to the joined substrate from the cavity substrate 20 side by, for example, an epoxy adhesive. Then, respective liquid droplet ejection heads are cut off by carrying out dicing, thereby each liquid droplet ejection head is completed (part F of FIG. 9).

As described above, in the electrostatic actuator (liquid droplet ejection head) of the embodiment 1, the individual electrode 12A as the fixed electrode is formed stepwise in the long side (length) direction. Further, the gap length between the vibration plate 22 as the movable electrode and the individual electrode 12A is made shortest in both the edge portion at which deflection starts and abutment begins, and made longer toward the central portion. Accordingly, when the vibration plate is displaced by generating electrostatic attracting force, a moment, which is larger than a case in which the individual electrode 12A is formed stepwise in a short side (width) direction, can be applied to the vibration plate 22, thereby the drive voltage can be effectively reduced. Then, the vibration plate 22 is formed stepwise in addition to the individual electrode 12A in conformity with it so that it is made thinner toward the central portion to increase compliance. Thus, the natural frequency is not reduced as compared with a case in which the thickness of the vibration plate 22 is uniformly thinned simply, and thus the response is less affected thereby. Since the central portion of the vibration plate 22 is thinned, even the central portion having a longest gap length can abut with a drive voltage for making both the edges of the vibration plate 22 abut, without being restrained by the relation which has to be satisfied by the proportional relation between restoring force and the gap length (relation in which the step difference of the individual electrode 12A is made smaller toward the central portion). As a result, the ejection performance of the liquid droplet ejection head can be increased by increasing the displacement of the vibration plate 22 by increasing the gap length of the central portion, and securing a desired amount of ejection by increasing the displaced volume. In particular, abutment along the line of the stepped portions of the fixed electrode 12A can be expected without increasing the natural frequency, by making the stepped portions of the individual electrode 12A as many as the stepped portions of the vibration plate 22 and making the vibration plate 22 abut against the individual electrode 12A well, thereby it is expected to further increase the displaced volume. Although the individual electrode 12A and the vibration plate 22 are formed stepwise so as to have the stepped portions here for convenience of manufacture, they may be formed to have, for example, an inclined surface and the like.

Further, in the above manufacturing method, when the boron diffused layer acting as the vibration plate 22 is formed, since boron is sequentially diffused for the number of stepped portions from a position at which the born is diffused deeply, the boron diffusion is carried out basically depending on the diffusion time of the boron to the portion where it is diffused deepest, thereby a time necessary to diffusion can be reduced.

### Embodiment 2

Portions A to G of FIG. 10 are views showing steps for forming a boron diffused layer acting as a vibration plate 22 according to an embodiment 2. In the embodiment 1 described above, boron is diffused several times into, a thickest portion and the like depending on the number of stepped portions. However, a method of the second embodiment is different from that of the first embodiment in that born is diffused into a desired position with a desired thickness (depth) by being diffused once. Since steps shown in parts A and B of FIG. 10 are the same as the first embodiment, explanation thereof is omitted.

In the portion of the silicon substrate 80, to which a boron diffused layer is formed thickest, silicon is exposed. Then, the silicon substrate 80 is put into a vertical furnace with the surface thereof, on which the boron diffused layer is to be formed, facing a solid boron diffusion source mainly composed of B₂O₃, and boron is diffused into the silicon exposed portion of the silicon substrate 80. With this step, a boron diffused portion 82 is formed. When the boron is diffused, a silicon oxide film 81 is removed (part C of FIG. 10).

Further, a silicon oxide (Si0₂) film 83 is formed on the surface of the silicon substrate. Then, the silicon oxide film 83 is patterned by photolithography by a method similar to the method described above, thereby the silicon substrate 80 is exposed at a predetermined position (part D of FIG. 10). The portion exposed here is the portion where a secondary thick boron diffused portion is to be formed. Thereafter, boron is diffused to a desired thickness into the portion where the silicon substrate 80 is exposed, by a method similar to the method described above. When the boron is diffused, the silicon oxide film 83 is removed (part E of FIG. 10).

A silicon oxide (Si0₂) film 84 is further formed on the surface of the silicon substrate 80. Then, the silicon oxide film 84 is patterned by photolithography by a method similar to the method described above, and the silicon substrate 80 in a predetermined portion is exposed (part F of FIG. 10). The portion to be exposed here is a portion where the thinnest boron diffused portion 82 is to be formed. Thereafter, boron is diffused to a desired thickness into the portion where the silicon substrate 80 is exposed, by a method similar to the method described above. After the boron is diffused, the silicon oxide film 84 is removed. With this step, the boron diffused layer, which is composed of three stepped portions and arranged as the vibration plate 22, is formed. An insulation film is formed on the surface where the boron diffused layer is formed, in a thickness of 0.1 μm by a method similar to the method of the embodiment 1 (part G of FIG. 10).

As described above, in the embodiment 2, when the boron diffused layer acting as the vibration plate 22 is formed, boron is diffused at one time as thick as the vibration plate 22 at a predetermined position, and this step is repeated so as to form the boron diffused layer acting as the stepwise vibration plate 22. As a result, since boron is not diffused into the same portion a plurality of times, a condition of roughness and the like can be made uniform in the surface where boron is diffused.

### Embodiment 3

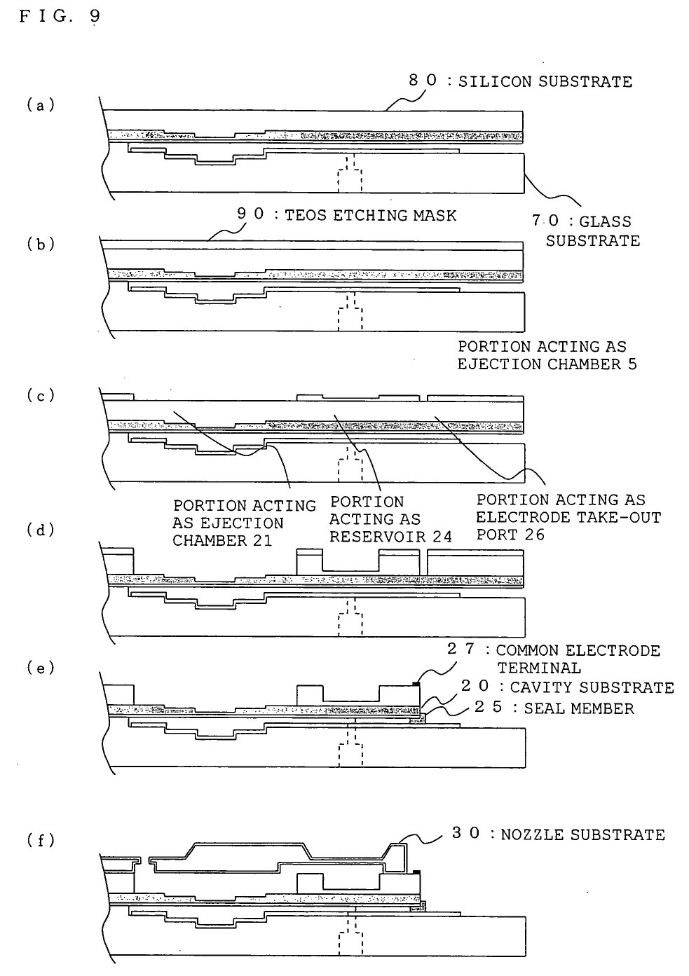

FIG. 11 is an outside appearance view of a liquid droplet ejection device using a liquid droplet ejection head manufactured in the embodiment described above. Further,

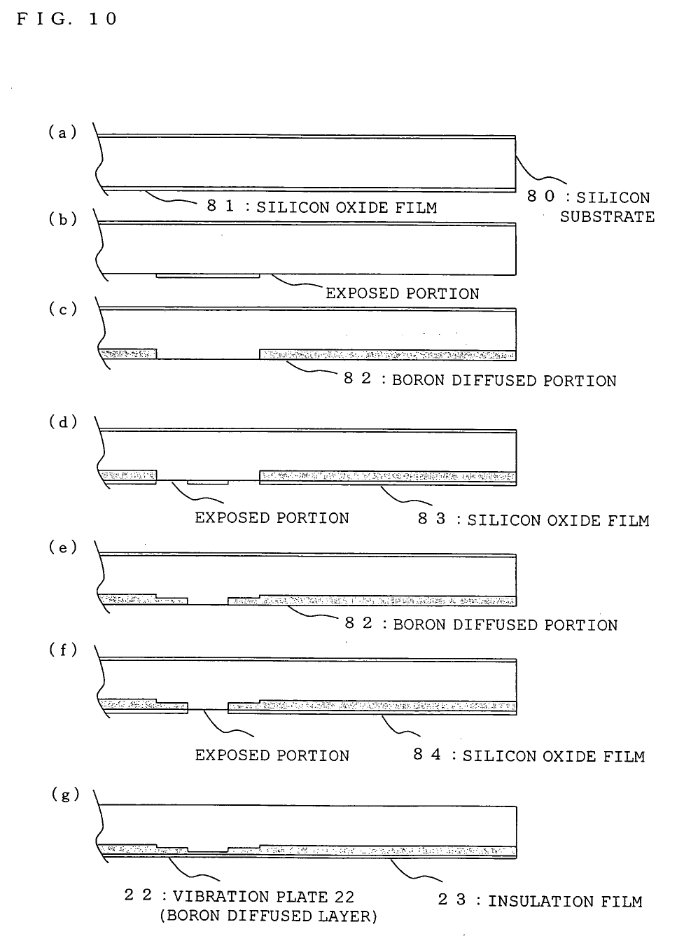

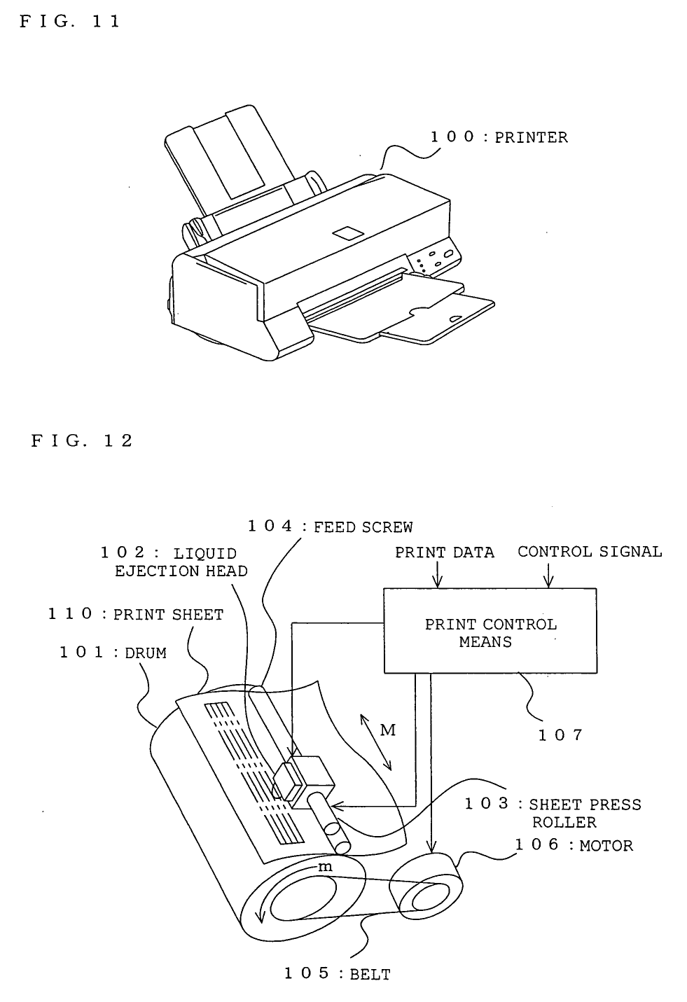

FIG. 12 is a view showing an example of main means for constituting the liquid droplet ejection device. An object of the liquid droplet ejection device of FIGS. 11 and 12 is to carry out print by a liquid droplet ejection system (inkjet system). Further, the liquid droplet ejection device is a so-called serial device. In FIG. 12, the liquid droplet ejection device is mainly composed of a drum 101 for supporting a print sheet 100 as a to-be-printed matter, and a liquid droplet ejection head 102 for ejecting ink to the print sheet 100 and carrying out recording. Further, although not shown, the liquid droplet ejection device also includes an ink supply means for supplying ink to the liquid droplet ejection head 102. The print sheet 110 is held by being pressed against the drum 101 by a sheet press roller 103 disposed in parallel with the axial direction of the drum 101. Then, a feed screw 104 is disposed in parallel with the axial direction of the drum 101, and the liquid droplet ejection head 102 is held by the feed screw 104. The liquid droplet ejection head 102 is moved in the axial direction of the drum 101 by rotating the feed screw 104.

On the other hand, the drum 101 is driven and rotated by a motor 106 through a belt 105 and the like. Further, a print control means 107 drives the feed screw 104 and the motor 106 based on print data and a control signal. Further, although not shown here, the print control means 107 vibrates a vibration plate 4 by driving an oscillation circuit, and causes the vibration plate 4 to carry out print onto the print sheet 110 while controlling it.

Although a liquid composed of ink is ejected onto the print sheet 110 here, the liquid to be ejected from the droplet ejection head is not limited to the ink. For example, in an application for ejecting a liquid onto a substrate acting as a color filter, ejecting a liquid onto a display substrate such as OLED and the like, or forming wirings on a substrate, a liquid containing pigment for the color filter, a liquid containing a compound acting as a light emitting element, or a liquid containing, for example conductive metal may be respectively ejected from liquid droplet ejection heads mounted on respective devices. Further, in an application in which a liquid droplet ejection head is used as a dispenser, and a liquid is ejected onto substrate acting as a microarray of biological molecule, a liquid containing a probe of DNA (deoxyribo nucleic acids), other Nucleic Acids (for example, ribo-nucleic acid, peptide nucleic acids, and the like), protein, and the like may be ejected. In addition to the above, the droplet ejection head may be also used for ejection and the like of dye for cloth and the like.

### Embodiment 4

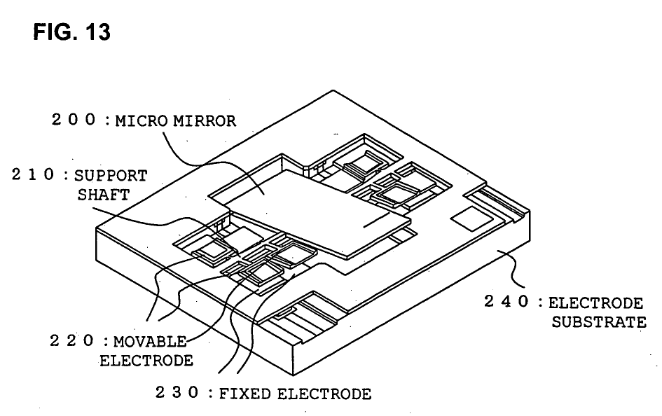

FIG. 13 is a view showing an optical switch using an electrostatic actuator making use of the present invention. The embodiment 3 described above is explained as to an example of the liquid droplet ejection head and the liquid droplet ejection device using it. However, the present invention is not limited thereto and can be applied to other micromachined devices and apparatuses.

The optical switch of FIG. 13 used in, for example, optical communication, optical calculation, an optical storage unit, an optical printer, a video display device, and the like achieves a role making use of an optical switching device for reflecting light in a selected direction by changing an inclined angle of a micormirror 200. To control the inclined angle of the micormirror 200, movable electrodes 220 acting as to-be-driven units are disposed at a position of, for example, line symmetry about a support shaft 210 for supporting the micormirror 200 and disposed in confrontation with a fixed electrodes 230 as drive units formed on an electrode substrate 240 so as to be and spaced apart from the movable electrodes 220 to define a predetermined gap. Then, the inclined angle of the micormirror 200 is controlled by rotating the support shaft 210 making use of electrostatic force. At the time, a movable electrode 220 can be more largely displaced than a conventional movable electrode with respect to a drive voltage by forming the movable electrode 220 and the fixed electrode 230 stepwise as in the embodiment 1 and the like, thereby the inclined angle of the micormirror 200 can be changed to a desired angle. Further, a combination of the movable electrode and the fixed electrode described above can be also applied to other types of micromachined electrostatic actuators such as a vibration element (resonator), such as, a motor, a sensor, a SAW filter, a wavelength-variable filter, other mirror device and the like likewise. In particular, in the liquid droplet ejection head, although the vibration plate acting as the movable electrode is supported at both the edges in the long side direction, the present invention can be also used in an actuator having a structure supported at one end.

What is claimed is:

1. An electrostatic actuator comprising a sheet-shaped movable electrode and a rectangular fixed electrode confronting the movable electrode and formed to have stepped portions in a long side direction with respect to the movable electrode, wherein the thickness of the movable electrode is reduced according to an order in which the movable electrode is made to abut against the fixed electrode by electrostatic attracting force generated between the movable electrode and the fixed electrode.

2. An electrostatic actuator comprising a sheet-shaped movable electrode and a rectangular fixed electrode having stepped portions or an inclined portion formed thereto in a long side direction such that a gap formed by confronting the movable electrode is increased from the edges thereof toward the central portion thereof, the fixed electrode generating electrostatic force in confrontation with the movable electrode, wherein the thickness of the movable electrode is reduced from the edges in the long side direction toward the central portion.

3. The electrostatic actuator according to claim 1, wherein the movable electrode is formed of stepped portions as many as those of the fixed electrode.

4. A liquid droplet ejection head comprising the electrostatic actuator according to claim 1, wherein a liquid is pressurized by the movable electrode and ejected from nozzles as droplets.

5. A liquid droplet ejection device on which the liquid droplet ejection head according to claim 4 is mounted.

6. An electrostatic driving device on which the electrostatic actuator according to claim 1 is mounted.

7. A method of manufacturing an electrostatic actuator comprising:
a step of forming a boron diffused layer acting as a movable electrode, which is displaced by electrostatic attraction force between the movable electrode and a rectangular fixed electrode formed stepwise or to have an inclined surface in a long side direction, by selectively diffusing boron into a silicon substrate while changing a depth of diffusion depending on a position so that the depth of diffusion is thinned as the width of a gap, which is formed when the movable electrode is caused to confront the fixed electrode, is increased; and
a step of forming the movable electrode by wet etching the silicon substrate while remaining only the boron diffused layer.

8. The method of manufacturing an electrostatic actuator according to claim 7, wherein when boron is diffused, a boron diffused layer having a different depth is formed by sequentially increasing selected positions from a position at which a boron diffused layer is formed thickest.

9. The method of manufacturing an electrostatic actuator according to claim 7, wherein when boron is diffused, a boron diffused layer is formed at one time at a selected position.

10. The method of manufacturing an electrostatic actuator according to claim 7, wherein the electrode substrate is formed by carrying out:
(1) a step of forming an etching mask on a substrate acting as an electrode substrate;
(2) a step of forming a rectangular opening portion having short sides and long sides by etching the etching mask;
(3) a step of forming a rectangular recessed portion having short sides and long sides to a portion confronting the opening portion of the etching mask by etching the substrate;
(4) a step of forming an opening portion longer than the previous opening portion in a long side direction by expanding the opening portion at both edges in the long side direction by etching the etching mask;
(5) a step of forming a stepwise recessed portion to a portion of the substrate confronting the longer opening portion of the mask, by etching the substrate;
(6) a step of forming a recessed portion having a desired number of stepped portions to the substrate by carrying out the steps (4) and (5) once or a plurality of times; and (7) a step of forming the fixed electrode so that its thickness is made uniform in the recessed portion.

11. A method of manufacturing a liquid droplet ejection head by applying the method of manufacturing an electrostatic actuator according to claim 7.

12. A method of manufacturing a liquid droplet ejection device by applying the method of manufacturing a liquid droplet ejection head according to claim 11.

13. A method of manufacturing an electrostatically driven device by applying the method of manufacturing an electrostatic actuator according to claim 7.

14. The electrostatic actuator according to claim 2, wherein the movable electrode is formed of stepped portions as many as those of the fixed electrode.
